(19) United States
(12) Patent Application Publication
(10) Pub. No.: US 2008/0223839 A1
(43) Pub. Date: Sep. 18, 2008

(54) Laser Machining Apparatus

(75) Inventors: Shigenobu Maruyama, Yokohama-shi (JP); Hiroshi Aoyama, Ebina-shi (JP); Masayuki Shiga, Ebina-shi (JP); Goichi Ohmae, Ebina-shi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi Via Mechanics, Ltd., Ebina-shi (JP)

(21) Appl. No.: 12/033,932

(22) Filed: Feb. 20, 2008

(30) Foreign Application Priority Data
Mar. 14, 2007 (JP) 2007-065153

(51) Int. Cl. B23K 26/02

(52) U.S. Cl. 219/121.83

(57) ABSTRACT

A laser machining apparatus capable of accurately projecting mask patterns onto a work piece and superior in machining accuracy. An auto-focusing unit is provided. The auto-focusing unit includes a television camera for observing alignment marks formed on the surface of the work piece so as to be able to measure the focal length of a projection lens. A main-scanning direction expansion/contraction ratio Ex of the work piece to its design value and a sub-scanning direction expansion/contraction ratio Ey of the work piece to its design value are obtained. The imaging magnification M of the projection lens is corrected to compensate the expansion/contraction ratio Ex. The moving speed of a mask and/or the moving speed of the work piece are corrected in consideration of the imaging magnification M of the projection lens so as to compensate the expansion/contraction ratio Ey.

### FIELD OF THE INVENTION

The present invention relates to a laser machining apparatus for irradiating a work piece with a laser beam having passed through a mask pattern, so as to machine a surface of the work piece.

### BACKGROUND OF THE INVENTION

With higher performance and smaller size of electronic instruments such as personal computers, thin TV sets, cellular phones, etc., wiring patterns in printed circuit boards serving as constituents of these instruments have been made finer in structure and higher in density. This tendency is conspicuous in a printed circuit board used for mounting a large-scale semiconductor chip. Such a printed circuit board will be referred to as “package substrate” hereafter. In recent years, wiring patterns have been made fine to be about 10-20 micrometers (μm) in minimum line width. In order to support the trend toward higher density and higher speed in semiconductor integrated circuits, it is believed that wiring patterns are requested to have signal transmission properties or the like as high-frequency transmission lines as well as finer structure and higher density.

A laminating method and a build-up method prevail widely as principal methods for manufacturing printed circuit boards. According to the laminating method, wiring patterns are formed in a copper-clad laminate using glass-fiber reinforced epoxy resin as base material by a photolithographic technique. Wiring layers formed thus and the insulating base material are put on top of one another alternately and bonded (hot-pressed) with one another. Thus, a plurality of wiring layers are built. The laminating method is a low-cost method which prevails most widely. On the other hand, according to the build-up method, wiring layers and insulating layers are formed alternately and built up into a multilayer wiring board. The build-up method requires a more complicated manufacturing technique than the laminating method. However, the build-up method can improve the accuracy of positioning interlayer patterns (or superposing layers on one another). Accordingly, the build-up method is suitable to attain finer structure and higher density of wiring patterns.

A package substrate is an intermediate substrate used for mounting (soldering) a semiconductor integrated circuit of the size of a cut wafer on a motherboard. The package substrate requires higher dimensional accuracy than a usual printed circuit board. Therefore, the package substrate is manufactured by the build-up method. In the existing circumstances, however, the build-up method generally includes a plating process also using a photolithographic process. For example, the whole surface of photo-resist applied to a large-area substrate of about 500 mm by 600 mm in size is exposed to light by use of a high-precision exposure apparatus. In addition, steps of resist application, exposure, development and separation must be repeated in the photolithographic process. Various defects may be built in during these steps. Progress of finer wiring patterns may increase the probability of occurrence of such defects. Further, a resist exposure apparatus supporting finer wiring patterns is more expensive. It is likely that improvement in performance of a package substrate leads to difficulty in reducing the manufacturing cost thereof.

In such circumstances, a new method (hereinafter referred to as “laser patterning method”) in which the photolithographic process has been made unnecessary in the conventional build-up method has been set up.

FIGS. 5A-5E are explanatory sectional views of the laser patterning method. FIG. 6 is a plan view of wiring patterns of a package substrate manufactured in the laser patterning method. A section taken along the line A-A in FIG. 6 corresponds to FIG. 5E. A method for manufacturing the package substrate using the laser patterning method will be described with reference to FIGS. 5A-5E and 6.

As shown in FIG. 5A, epoxy resin 104 is applied to the top of a lower wiring layer 100 which is composed of epoxy resin 101 as an interlayer insulating material and conductor patterns 102 and 103 as lower wiring patterns. After the epoxy resin 104 is cured, via holes 105 and 106 are formed by a general-purpose laser via machining apparatus using a carbon dioxide laser or an ultraviolet laser as a light source. The opening of each via hole 105, 106 is about 40 μm in diameter at the bottom, about 50 μm at the top and about 50 μm in depth. Next, as shown in FIG. 5B, groove patterns 108-110 are formed in the surface of the insulating layer (epoxy resin 104). Each groove pattern is 5-20 μm in width and 5-20 μm in depth. The groove patterns are formed by ablation machining with an ultraviolet laser such as an excimer laser. As shown in FIG. 5C, a surface processing step also serving for removing a machining residue adhering to the surface is applied to the substrate where the groove patterns have been formed. Thus, electroless plating 111 is applied to the whole surface of the epoxy resin 104. After that, as shown in FIG. 5D, a plating layer is formed all over the surface of the epoxy resin 104 by electrolytic plating. Unnecessary plated amount is removed in a grinding step. Thus, wirings 113-115 are formed in the groove patterns 108-110 as shown in FIG. 5E. Subsequently the aforementioned steps in FIGS. 5A-5E are repeated to build a plurality of wiring layers without using any photolithographic process.

One of problems of the laser patterning method is how to establish the groove patterning process shown in FIG. 5B. That is, as shown in FIG. 6, land portions are often provided in the wiring patterns 113-115 of a printed circuit board so as to secure connection with the via holes 105-107. In order to improve the pattern mounting density of the printed circuit board, a diameter D of each land must be made as small as possible, and the wiring patterns 113-115 must be formed to reduce positional misalignment with lower wiring layers or the via holes 105-107. Package substrates are expected to be finer also in pattern wiring width W in the future. It is therefore necessary to use a means capable of controlling positions or dimensions of machined patterns with high precision in order to form the laser groove patterns 108-110.

There is a method for precisely machining a surface of a macromolecular material such as epoxy resin, wherein patterns formed on a mask are imaged on a surface of a work piece by a projection lens, and the surface of the work piece is scanned with an excimer laser beam shaped by an aperture stop, so that a surface of a large-area substrate can be machined uniformly and efficiently with mask patterns projected thereon (Patent Document 1).

In an optical configuration of a lithography apparatus using an excimer laser beam, a mask and a work piece (wafer) are kept in a conjugate relation with respect to a projection lens. The mask is irradiated with the excimer laser beam shaped into a specific shape while the mask and the work piece are moved simultaneously. Thus, a wider area than the field of the projection lens or a wider area than the laser-irradiated area can be exposed to light uniformly. Such an optical configuration can be applied as a high-precision laser machining optical system (Patent Document 2 or 3).

According to the aforementioned techniques disclosed in Patent Documents 1-3, the energy density of light made incident on a substrate surface can be made constant.

Patent Document 1: Japanese Patent No. 3285214

Patent Document 2: Japanese Patent No. 2960083

Patent Document 3: JP-A-6-232030

In the manufacturing method shown in FIGS. 5A-5E and 6, a large number of heating processes such as plating, curing epoxy resin, and so on, are repeated to build wiring layers on top of one another. During the manufacturing processes, a work piece is thermally deformed so that wiring patterns formed on the work piece may be displaced, expanded or contracted. On the other hand, the laser-machined patterns on the work piece which is, for example, 50 mm square must be positioned with an accuracy of ±5 μm or less with respect to alignment marks on the work piece or alignment marks provided on a lower layer.

In order to improve the machining speed, it is typical to use a method in which light energy of power as high as possible is introduced into a machining optical system while a work piece is moved at a high-speed. For example, in the pattern forming process shown in FIG. 5B, an XeCl excimer laser with an average power of 100 W or higher is used. When light energy of an average power of 100 W or higher is introduced into the machining optical system, a change of an optical constant affected by heat cannot be left out of consideration. That is, when machining is repeated with high light power, the focal length of a projection lens changes gradually. Accordingly the imaging magnification of mask patterns changes so that the dimensions of patterns projected (machined) on the work piece may vary with time. Thus, the machining accuracy deteriorates.

However, the aforementioned Patent Documents 1-3 have no consideration about the displacement, expansion or contraction of wiring patterns formed on the work piece, or the change of imaging magnification of the projection lens affected by heat. It is therefore impossible to obtain required dimensional accuracy of patterns when the techniques disclosed in Patent Documents 1-3 are applied to manufacturing a package substrate.

### SUMMARY OF THE INVENTION

An object of the present invention is to solve the foregoing problem. Another object of the present invention is to provide a laser machining apparatus capable of accurately projecting mask patterns onto a work piece and superior in machining accuracy.

In order to attain the foregoing objects, the present invention provides a laser machining apparatus in which a mask and a work piece are disposed in conjugate relationship to each other with respect to a projection lens, and the mask and the work piece are moved simultaneously so that patterns formed in the mask are projected onto the work piece to thereby machine the work piece. The laser machining apparatus is characterized in that a module for observing alignment marks formed in a surface of the work piece is provided, a main-scanning direction expansion/contraction ratio Ex of the work piece to a designed value thereof and a sub-scanning direction expansion/contraction ratio Ey of the work piece to a designed value thereof are obtained, an imaging magnification M of the projection lens is corrected to compensate the expansion/contraction ratio Ex, and a moving speed of the mask and/or the work piece is corrected in consideration of the imaging magnification M of the projection lens so as to compensate the expansion/contraction ratio Ey.

In this case, a rotating stage for either rotating a work piece stage which can move with holding the work piece, or rotating a module for holding the mask may be provided. When there is a rotational misalignment between the work piece and the mask, the misalignment can be corrected by the rotating stage.

In addition, a focal length measuring module for measuring a focal length of the projection lens, and two moving modules for moving two of the projection lens, the mask rotating stage and the work piece rotating stage along the optical axis of the projection lens respectively may be provided. When the focal length shifts from a predetermined value, the two moving modules can be operated to keep the imaging magnification M constant.

In this case, the focal length measuring module may be formed as a confocal optical system using the projection lens.

Further, a module for observing the surface of the work piece by use of the projection lens may be provided.

According to the present invention, mask patterns can be projected onto a work piece accurately.

### BRIEF DESCRIPTION OF THE DRAWINGS

FIG. 1 illustrates a configuration of a laser machining apparatus according to the present invention;

FIG. 2 is a plan view (Cr pattern plan view) of a mask used in the present invention;

FIG. 3 is an explanatory diagram of an auto-focusing unit according to the present invention;

FIG. 4 is a view showing the specification of a work piece;

FIGS. 5A-5E are sectional views for explaining a laser patterning method; and

FIG. 6 is a plan view of wiring patterns of a package substrate manufactured in the laser patterning method.

### DETAILED DESCRIPTION OF THE EMBODIMENT

The present invention will be described below.

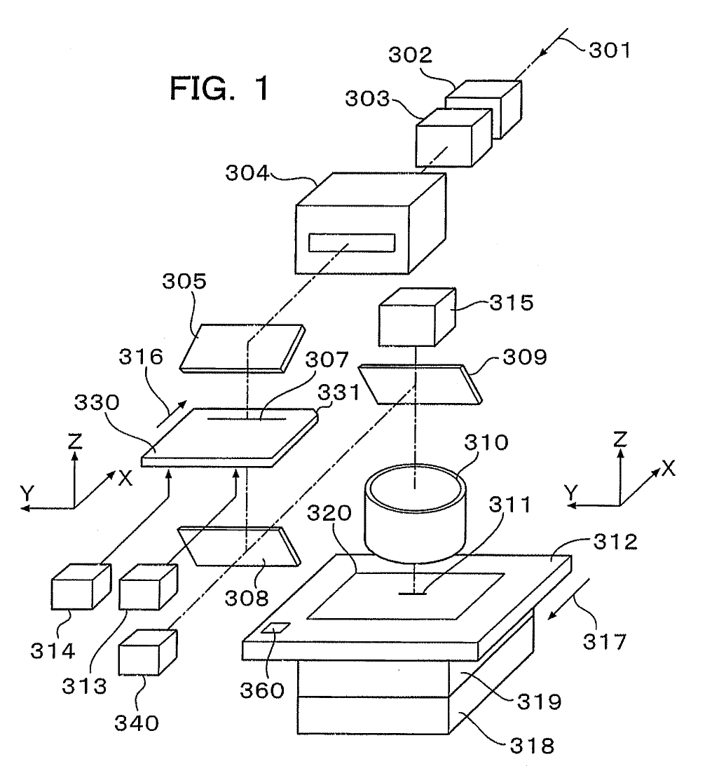

FIG. 1 illustrates a configuration of a laser machining apparatus according to the present invention.

A laser beam 301 emitted from a not-shown XeCl excimer laser oscillator (oscillation wavelength of 308 nm) is attenuated to a desired light intensity by an attenuator 302. The laser beam 301 is formed into a parallel beam by a collimator 303, and incident on a beam shaper 304. The beam shaper 304 changes the aspect ratio of the laser beam 301 incident thereon. The laser beam 301 emerges as a laser beam 307 having a substantially uniform (around ±3%) spatial intensity distribution. In this embodiment, the laser beam 307 measures 5 mm (X-direction) by 130 mm (Y-direction). The optical path of the laser beam 307 is deflected by a reflecting mirror 305, and the laser beam 307 is incident on a mask 330.

The mask 330 is fixedly positioned on a not-shown mask stage. The mask stage has moving mechanisms for X-, Y-, Z- and θ-axes. The θ-axis is a rotation axis normal to the XY plane. The material of the mask 330 is quartz glass. The effective opening area of the mask 330 measures 125 mm by 125 mm. Circuit wiring patterns made of a Cr material are formed on the back side (opposite side to the surface where the laser beam 307 will be incident) of the mask 330. The optical path of the laser beam 307 having passed through the mask 330 is deflected at a right angle by dichroic mirrors 308 and 309. The laser beam 307 is incident on a projection lens 310.

The projection lens 310 is color-corrected for the laser oscillation wavelength (308 nm) and specific visible light (for example, wavelength around 550 nm). The projection lens 310 has a focal length f of 150 mm. The pattern surface of the mask 330 and the surface of the work piece 320 have a conjugate relation with respect to the projection lens 310. The circuit wiring patterns of the mask 330 are projected onto the work piece 320 in a reduction ratio of 1/5 by the projection lens 310. A laser-irradiated area 311 on the work piece 320 measures up to 1 mm (X-direction) by 25 mm (Y-direction).

The work piece 320 is positioned on a work piece stage 312 by vacuum suction. The work piece stage 312 is mounted on an XYZ stage 318 and a θ stage 319. The θ axis is a rotation axis normal to the XY plane. A reflecting mirror 360 which is 10 mm square is provided on the work piece stage 312. The reflecting mirror 360 is made of metal film such as aluminum film deposited on optical glass.

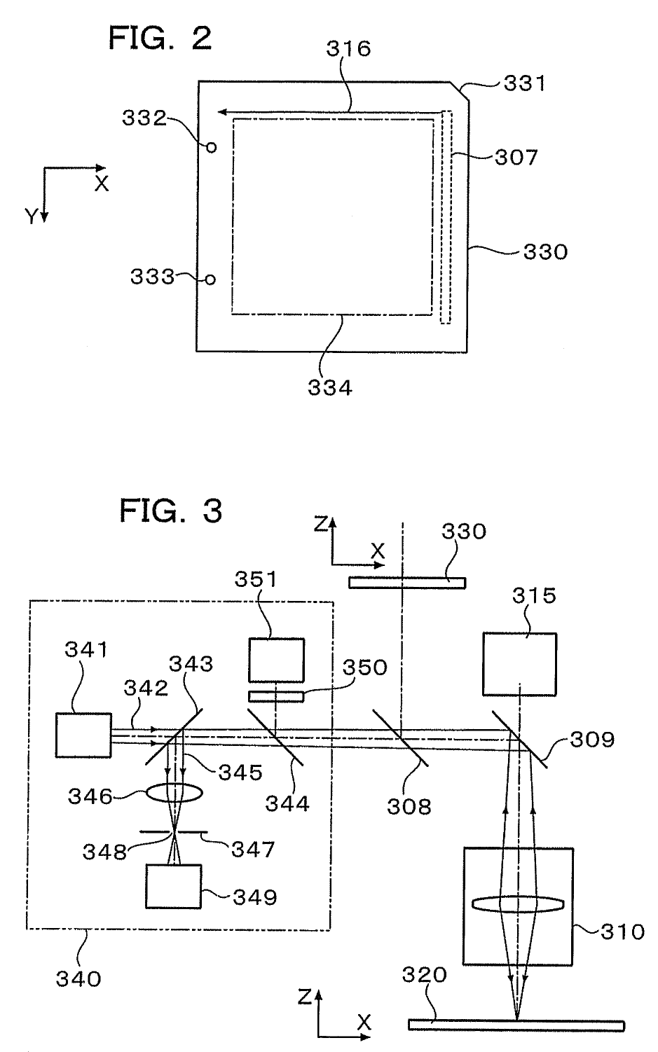

FIG. 2 is a plan view (Cr pattern plan view) of the mask 330 used in the present invention. The mask 330 in this embodiment is provided with a chamfer 331 for preventing its front and back from being mixed up and preventing its fixing direction from being mistaken. The external shape of the mask 330 is 200 mm square. Inside the mask 330, there is an effective opening area 334 which is 125 mm square as shown by the dashed dotted line. Inside the effective opening area 334, circuit wiring patterns of package substrates are formed. Outside the effective opening area 334, reference marks 332 and 333 serving for recognizing the position where the mask 330 should be fixed are disposed. The circuit wiring patterns and the reference marks 332 and 333 are Cr patterns formed in a lump by a photolithographic process.

FIG. 3 is an explanatory diagram of an auto-focusing unit according to the present invention.

The principal of a typical confocal optical system is applied to the configuration of the auto-focusing unit. That is, the work piece 320 is irradiated with a laser beam 342 emitted from a semiconductor laser 341 through the projection lens 310. The beam reflected by the surface of the work piece 320 is reflected by a half mirror 343 and concentrated by a converging lens 346. The concentrated beam is received by a photo-sensor 349. The parallelism of the laser beam 342 emitted from the semiconductor laser 341 can be adjusted to control a converging position 348 of a return beam 345 converged by the converging lens 346. The amount of light passing a pin hole 347 disposed at the converging position 348 varies in accordance with the surface displacement of the work piece 320. Thus, the surface displacement of the work piece 320 can be measured with accuracy of about 1 μm.

An auto-focusing unit 340 includes a television camera 351 for observing the surface of the workpiece 320 through the projection lens 310 and reflected from a half mirror 344. The reference numeral 315 represents a light source for observing the surface of the work piece 320. In this embodiment, a metal halide lamp is used as the light source 315. In order to obtain a clear image by the television camera 351, a green band-pass filter 350 is used to suppress the chromatic aberration of the projection lens 310.

Next, the operation of the laser machining apparatus configured thus will be described.

First, before starting a laser machining, the mask 330 is fixed to a not-shown mask stage. When the mask 330 is fixed, mask alignment units 313 and 314 each including a television camera and a light source recognize images of the reference marks 332 and 333 on the mask 330 respectively. A θ-rotational displacement and X- and Y-direction displacements of the mask 330 with respect to a design reference position are calculated. The θ-, X- and Y-axes of the mask stage are adjusted to eliminate the θ-rotational displacement and the X- and Y-direction displacements of the mask 330. By the aforementioned operation, the initial position of the mask 330 is determined. On this occasion, a laser-irradiated position 307 on the mask 330 is set in a predetermined position outside the effective opening area 334 of the mask 330 as shown by the broken line in FIG. 2.

Next, the work piece 320 is mounted in a predetermined position on the work piece stage 312. Then an instruction to start machining is given to the laser machining apparatus. Based on information from a host computer which administrates design information about printed circuit boards, a not-shown apparatus control portion moves the work piece stage 312 in the X- and Y-directions, and positions the central axis (center of field of view) of the projection lens 310 in a design center of an alignment mark of the work piece 320. The focus is adjusted on the surface of the work piece 320 by the auto-focusing unit 340.

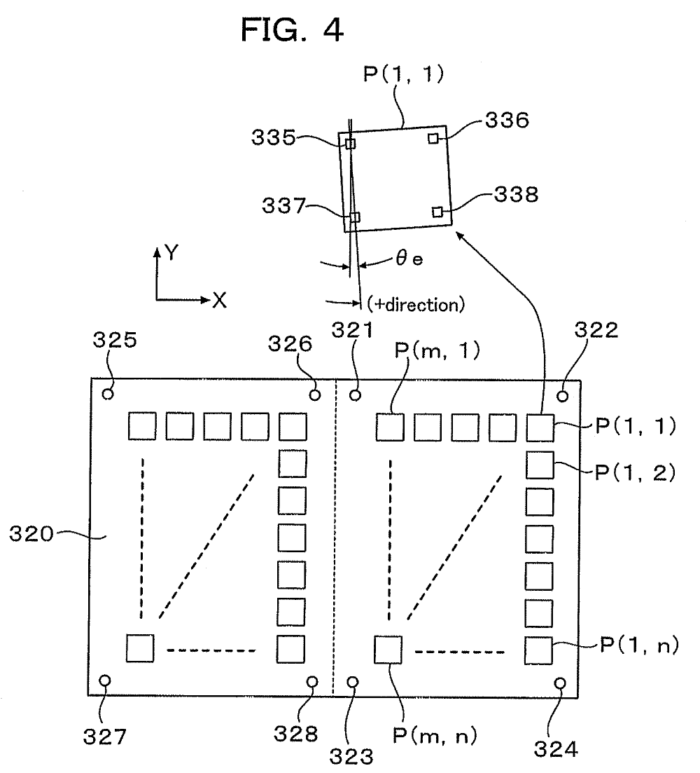

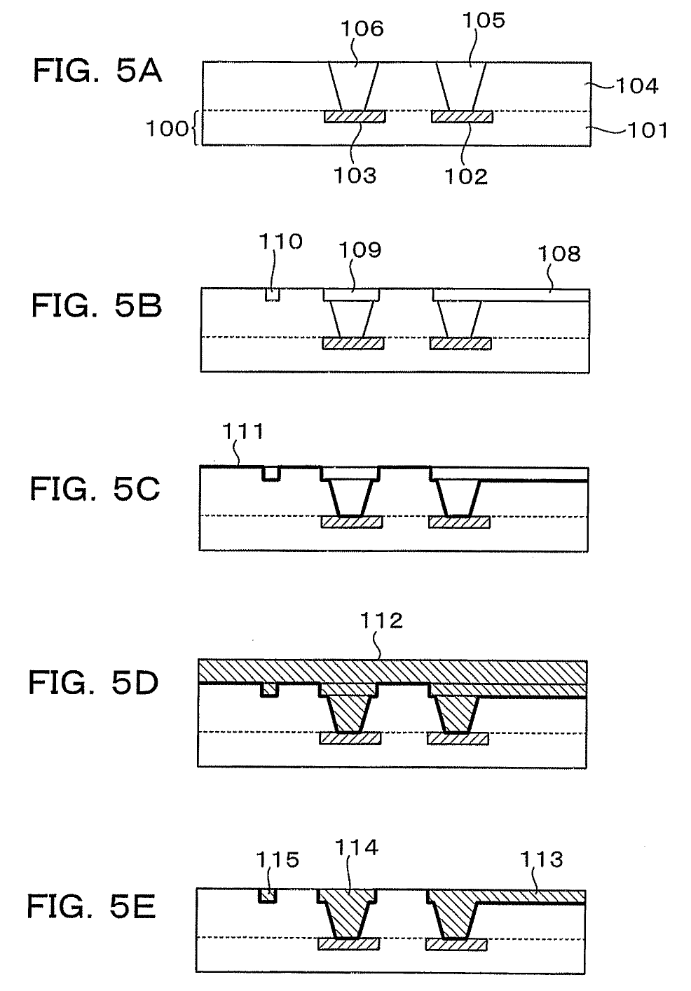

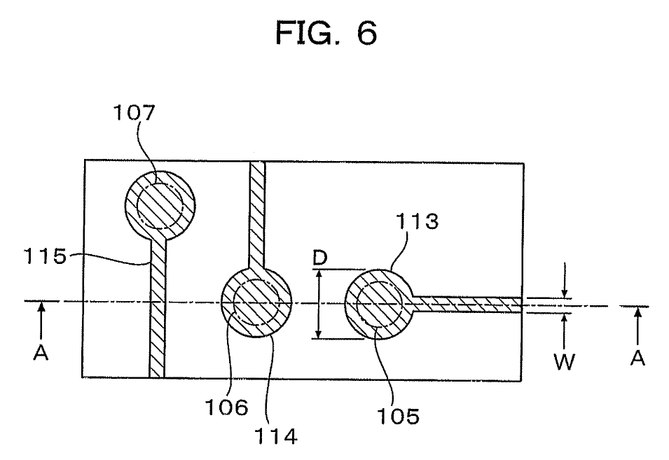

FIG. 4 is a view showing the specification of the work piece 320.

The work piece 320 is a substrate having multiple patterns of package substrates P each 25 mm square. Identical patterns are arranged in m columns and n rows on the work piece 320. The work piece 320 as a whole measures 400 mm (X-direction) by 300 mm (Y-direction). Two pattern groups each having the identical patterns arranged in m columns and n rows are disposed separately in the work piece 320. Alignment marks 321-328 are through holes in the insulating base material (epoxy resin) of the work piece 320 by a mechanical drill.

Next, the alignment marks 321-328 are moved into the field of view of the television camera 351 sequentially. The focus position (Z-axis direction position) is adjusted by the auto-focusing unit 340. Based on image recognition, the coordinates of the alignment marks 321-328 are stored in the apparatus control portion. The apparatus control portion drives the XYZ stage 318 based on the stored coordinates of the alignment marks 321-328 so as to position the first pattern P(1, 1) just under the projection lens 310. Further, local alignment marks 335-338 (which have been formed, for example, formed on the work piece 320 with circuit wiring patterns) of the pattern P(1, 1) are observed sequentially by the television camera 351. The centroidal coordinates (XY coordinates) of each local alignment mark are measured. Thus, the accurate position of the formed pattern P(1, 1) in the XY plane and the expansion/contraction state of the work piece 320 affected by thermal history are calculated.

For example, the rotational component θe (angle) of the pattern P (1, 1) can be calculated from the relative positional relationship between the alignment marks 335 and 337. Here, the rotational component θe designates an angle between the Y-axis of the XYZ stage 318 and a straight line connecting the alignment marks 335 and 337 by the shortest distance. Assume that it turns out that the rotational component θe appears in the positive direction (clockwise direction). The θ stage 319 is rotated in the negative direction (counterclockwise direction) by the same angle as the rotational component θe so as to cancel the rotational component θe. The rotational component θe of the pattern P(1, 1) may be calculated by a method using the alignment marks 336 and 338 or a method using the alignment marks 335 and 336. Alternatively, the rotational component θe may be regarded as an average value of the results calculated by those methods.

A Y-axis direction expansion/contraction ratio Ey of the pattern P(1, 1) can be calculated from the relative positional relationship between the alignment marks 335 and 337. Here, the expansion/contraction ratio Ey designates a ratio of a measured value of the straight-line distance between the alignment marks 335 and 337 to the designed value thereof. Here, the expansion/contraction ratio Ey which is higher than 1 means that the pattern P(1, 1) on the work piece 320 has been expanded in the Y-axis direction. On the contrary, the expansion/contraction ratio Ey which is lower than 1 means that the pattern P(1, 1) on the work piece 320 has been contracted in the Y-axis direction. The expansion/contraction ratio Ey may be calculated by a method using the alignment marks 336 and 338. Alternatively, in consideration of the result of calculation using the alignment marks 335 and 337, the expansion/contraction ratio Ey may be regarded as an average value of the two calculation results.

In the same manner, an X-axis direction expansion/contraction ratio Ex of the pattern P(1, 1) can be calculated from the relative positional relationship between the alignment marks 335 and 336. The X-axis direction expansion/contraction ratio Ex may be calculated by a method using the alignment marks 337 and 338. Alternatively, in consideration of the result of calculation using the alignment marks 335 and 336, the expansion/contraction ratio Ex may be regarded as an average value of the two calculation results.

Even if the expansion/contraction ratio Ey of a pattern is very slight, for example, 0.02%, it will be equal to an error of 7 μm on a diagonal line of a machined pattern which is 25 mm square. The error may lead to a fatal dimensional error in the process of manufacturing package substrates according to the present invention. In this embodiment, the imaging magnification M of a machined pattern is corrected when the Y-axis direction expansion/contraction ratio Ey of the pattern P(1, 1) is different from its designed value.

Next, a method of correcting the imaging magnification M in this embodiment will be described.

Assume that a designates a distance between an object point (mask surface) and a principal point of a projection lens, b designates a distance between an image plane (work piece surface) and the principal point of the projection lens, f designates a focal length of the projection lens, and M designates an imaging magnification of the projection lens. In this case, the following Expressions 1 and 2 are established in a general imaging optical system.

1/a+1/b=1/f (1)

M=b/a (2)

When the initial conditions of f=150 mm and M=0.2 times are applied to Expressions 1 and 2, a=900 mm and b=180 mm are obtained. It would be ideal if these designed values (normal optical constants) were always kept, and the work piece 320 were machined with patterns of the mask 330 projected thereon in the constant imaging magnification, during the operation of the laser machining apparatus.

It is understood from Expression 2 that the imaging magnification M of the projection lens 310 can be corrected if the ratio between the distance a and the distance b is changed. On this occasion, the distance a and the distance b must satisfy Expressions 1 and 2 at once. On the other hand, long time operation of the laser machining apparatus leads to variation with time in the focal length f of the projection lens 310 due to a change in the operating rate of the apparatus or a change in the environmental temperature of the installation location. In order to obtain a desired imaging magnification Mo, it is therefore necessary to grasp the focal length f of the projection lens 310. When the reflecting mirror 360 is placed in the field of view of the projection lens 310 and the surface position of the reflecting mirror 360 is measured by the auto-focus unit 340, the change of the focus position of the projection lens 310 can be detected accurately as a change in the Z-axis displacement of the XYZ stage 318.

Next, a method of correcting the imaging magnification Mo will be described.

For example, assume that the focus position of the projection lens 310 has moved 0.144 mm (corresponding to b=180.144 mm) in the −Z direction relatively to its initial value (position corresponding to b=180 mm) under the condition that the distance a is fixed. In this case, a focal length fs after variation with time can be obtained as 150.1 mm from Expression 1.

If the expansion/contraction ratio Ey is 1.0004 (corresponding to expansion of 0.04%), a desired imaging magnification My in the Y-axis direction can be obtained as 1.0004×0.2 (normal pattern imaging magnification)=0.20008 times. Since the focal length fs of the projection lens 310 has been known, the distances a=900.3 mm and b=180.132 mm can be obtained from Expressions 1 and 2. Therefore, the Z displacement of the mask stage mounted with the mask 330 is moved by 0.3 mm so as to increase the distance a. After that, when the focus position is detected on the reflecting mirror 360 by the auto-focusing unit 340, the distance b can be detected to be 0.132 mm longer than its initial value (180 mm). That is, when the Z-axis direction positions of the mask 330 and the work piece stage 312 are changed in the state where the position of the projection lens 310 is fixed, the distances (optical path lengths) a and b can be corrected to adjust the imaging magnification Mo to a desired value (0.20008 times).

As has been described above, according to the apparatus of the present invention, the pattern P(1, 1) to be machined is positioned in the laser irradiated area 311 after the θ-rotational displacement θe of the pattern P(1, 1) and the pattern imaging magnification My (based on the pattern expansion/contraction ratio Ey in the Y-axis direction) are corrected. The laser beam in the laser irradiated area 311 measures 1 mm (X-direction) by 25 mm (Y-direction).

As soon as all the preparations for the state of laser machining are completed, the XeCl excimer laser oscillator begins to operate at a pulse repetition frequency of 100 Hz. After that, the mask 330 and the work piece stage 312 move at a constant speed in the directions of arrows 316 and 317 respectively. Here, assume that F [Hz] designates the laser repetition frequency, w designates the laser irradiation size in the X-axis direction on the work piece 320, and Vs [mm/s] designates the scanning speed of the work piece stage 312. In this case, the number n of laser pulses, which strike on a position on the surface of the work piece 320, is determined by Expression 3.

n=F×w/Vs (3)

That is, for example, the number n reaches 20 (pulses) when the work piece stage 312 moves at 5 mm/s.

If the pattern expansion/contraction ratio Ex in the X-axis direction is 1.0002 (corresponding to expansion of 0.02%), a desired imaging magnification Mx in the X-axis direction must be set as 1.0002×0.2 (normal imaging magnification)=0.20004 times. However, the imaging magnification of the imaging lens 310 has been changed as My based on the pattern expansion/contraction ratio Ey in the Y-axis direction. Accordingly, the moving speed Vm [mm/s] of the mask stage is set at a value determined by Expression 4 using the scanning speed Vs of the work piece stage 312, the pattern expansion/contraction ratio Ex in the X-axis direction and the pattern expansion/contraction ratio Ey in the Y-axis direction.

Vm=Vs/(Ex/Ey×0.2) (4)

As described above, the imaging magnification My of the projection lens 310 has been set at 0.20008 times. Accordingly, the X-axis direction size of 5 mm of the laser beam emerged from the mask 330 becomes 1.0004 mm on the work piece 320. When the number n of laser pulses on the work piece 320 is constant (20 pulses), the scanning speed Vs of the work piece stage 312 can be obtained as 5.002 mm/s from Expression 3.

That is, for example, when the work piece stage 312 is scanned at 5.002 mm/s under the conditions of Ex=1.0002 and Ey=1.0004, the scanning speed Vm of the mask stage can be obtained as 25.015 mm/s from Expression 4.

In this embodiment, the laser irradiation energy density on the surface of the work piece 320 is about 1 J/cm² per pulse. Assume that machining is performed under the condition where the number n of pulses is set as 20 pulses. In this case, the machining depth of epoxy resin reaches about 15 μm. The patterns of the mask 330 can be transferred (or projected and machined) onto the surface of the work piece 320 with uniform depth.

Here, additional description will be made about the laser irradiation energy density when the imaging magnification is changed.

When the imaging magnification My of the projection lens 310 is set at 0.20008 times, the laser irradiation energy density on the work piece 320 is expressed as 1/Ey². When Ey=1.0004, the aforementioned energy density 1 J/cm² is reduced to 0.9992 J/cm², but the energy density can be regarded as substantially unchanged.

If necessary, the laser power of the excimer laser oscillator may be increased or reduced to adjust the laser irradiation energy density on the work piece 320.

When machining for the pattern P(1, 1) on the work piece 320 is completed, the mask 330 returns to its initial position where the mask 330 had been placed before the machining. The position of the mask 330 is confirmed by the mask alignment units 313 and 314. When there is a displacement, the initial position of the mask 330 is adjusted again by the not-shown mask stage. A rotation around the θ axis for the next pattern P(1, 2) to be machined on the work piece 320 is detected, and then the machining is repeated in the aforementioned procedure. The other patterns are machined in the same manner one after another.

The rotation around the θ axis may be corrected for every pattern group including an arbitrary predetermined number of patterns in accordance with necessity.

The focal length of the projection lens 310 may be also measured again not for every pattern to be machined, but for every work piece 320 or about once an hour. In this manner, the machining throughput of the laser machining apparatus can be improved.

As has been described above, according to the present invention, machining is performed while the position of the XYZ stage 318, the imaging magnification of the projection lens 310 and the relative scanning speed between the mask 330 and the work piece stage 312 are corrected based on the pattern displacement, the X-axis direction (main-scanning direction of laser irradiation) expansion/contraction ratio Ex and the Y-axis direction (sub-scanning direction of laser irradiation) expansion/contraction ratio Ey detected for every pattern to be machined or for every pattern group. It is therefore possible to manufacture high-performance package substrates.

In the aforementioned embodiment, the θ stage 319 is rotated to correct the rotational displacement of a pattern to be machined. However, the rotational displacement can be corrected around the θ axis of the mask stage which holds the mask 330.

In the aforementioned embodiment, the Z-axis direction positions of the mask 330 and the work piece stage 312 are adjusted to correct the imaging magnification of the projection lens 310. However, the Z-axis direction position of the mask 330 and the projection lens 310 may be adjusted while the position of the work piece stage 312 is fixed. According to an alternative method, the Z-axis direction positions of the projection lens 310 and the work piece stage 312 may be adjusted while the position of the mask 330 is fixed. In any method, the imaging magnification of the projection lens 310 can be corrected by adjustment of the Z-axis direction positions of at least two of the mask 330, the projection lens 310 and the work piece stage 312.

1. A laser machining apparatus comprising:
a fixed projection lens with respect to which a mask and a work piece are disposed in conjugate relationship to each other, the mask and the work piece being moved simultaneously so that patterns formed in the mask are projected onto the work piece to thereby machine the work piece; and
a module for observing alignment marks formed in a surface of the work piece; wherein:
a main-scanning direction expansion/contraction ratio Ex of the work piece to a designed value thereof and a sub-scanning direction expansion/contraction ratio Ey of the work piece to a designed value thereof are obtained;
an imaging magnification M of the projection lens is corrected to compensate the expansion/contraction ratio Ex; and
a moving speed of the mask and/or the work piece is corrected in consideration of the imaging magnification M of the projection lens so as to compensate the expansion/contraction ratio Ey.

2. A laser machining apparatus according to claim 1, further comprising:
a rotating stage for either rotating a work piece stage which can move holding the work piece, or rotating a module for holding the mask; wherein:
when there is a rotational misalignment between the work piece and the mask, the misalignment is corrected by the rotating stage.

3. A laser machining apparatus according to claim 1, further comprising:
a focal length measuring module for measuring a focal length of the projection lens; and
two moving modules for moving two of the projection lens, the mask rotating stage and the work piece rotating stage along an optical axis of the projection lens respectively; wherein:
when the focal length shifts from a predetermined value, the two moving modules are operated to keep the imaging magnification M constant.

4. A laser machining apparatus according to claim 3, wherein the focal length measuring module is a confocal optical system using the projection lens.

5. A laser machining apparatus according to claim 1, further comprising:
a module for observing the surface of the work piece by use of the projection lens.

6. A laser machining apparatus according to claim 2, further comprising:
a focal length measuring module for measuring a focal length of the projection lens; and
two moving modules for moving two of the projection lens, the mask rotating stage and the work piece rotating stage along an optical axis of the projection lens respectively; wherein:
when the focal length shifts from a predetermined value, the two moving modules are operated to keep the imaging magnification M constant.

7. A laser machining apparatus according to claim 2, further comprising:
a module for observing the surface of the work piece by use of the projection lens.
